(19) United States
(12) Patent Application Publication
(10) Pub. No.: US 2019/0329630 A1
(43) Pub. Date: Oct. 31, 2019

(54) HIGH ASPECT RATIO VENT AIMING USING SINGLE BARREL MECHANISM

(71) Applicant: NIO USA, Inc., San Jose, CA (US)

(72) Inventors: Ren Ren, San Jose, CA (US); Ming Fung Wong, San Jose, CA (US); Matthew S. Filipkowski, Pleasanton, CA (US)

(21) Appl. No.: 15/964,417

(22) Filed: Apr. 27, 2018

(51) Int. Cl. B60H 1/34

(52) U.S. Cl. CPC B60H 1/3414; B60H 2001/3478; B60H 1/345

(57) ABSTRACT

An air vent achieves selective vertical aiming of air by using a barrel comprising two vanes defining a central channel to selectively channel air, in varying proportions, into one or both of an upper air channel and a lower air channel. The upper air channel is configured to discharge air into a vehicle passenger cabin at a downward angle, and the lower air channel is configured to discharge air into the vehicle passenger cabin at an upward angle. Air discharged by the upper air channel impinges on and deflects air discharged by the lower air channel and vice versa, such that vertical aiming can be achieved by varying the mass flow rate of air through the upper and lower air channels.

### FIELD

The present disclosure is generally directed to vehicle systems, and more particularly to vehicle ventilation systems.

### BACKGROUND

Heating, ventilation, and cooling (“HVAC”) systems have long been included in automobiles, whether as standard or optional equipment. Such systems typically comprise an HVAC module, which receives air, conditions the air as necessary (whether by heating or cooling, although in some instances no conditioning is needed or effected), mixes the air as necessary (e.g., mixes cooled air with fresh air or warm air with fresh air to achieve a desired air temperature), and blows the air through one or more ducts to one or more vents in the passenger cabin of the vehicle. HVAC modules thus selectively provide air, for example, to dashboard-mounted or dash-level vents, ceiling and sidewall mounted vents, floor-mounted or foot-level vents, and defrosting vents. Conventionally, automotive air vents may be manually adjusted to blow air in different directions by rotating hinged vertical vanes positioned at a vent outlet toward the left or right for horizontal aiming, and by rotating hinged horizontal vanes positioned at a vent outlet upward or downward for vertical aiming. In some embodiments, a vent may be rotatably secured to an air duct so that rotation of the entire vent permits aiming in a horizontal or vertical direction, and rotation of vanes positioned within the vent permits aiming in a vertical or horizontal direction, respectively.

U.S. Patent Application Publication No. 2017/0253107, entitled “Thermal system with high aspect ratio vent” and published on Sep. 7, 2017, describes the use of one stream of air to “unstick” another stream of air, discharged from a vent with a relatively shallow angle with an adjacent surface, from the surface. U.S. Pat. No. 8,584,709, entitled “Valve with operating means between two outlet passages” and granted on Nov. 19, 2013, describes a butterfly valve used to direct fluid mainly into a first duct in a first extreme position and mainly into a second duct in a second extreme position. The entirety of these references, with the exception of anything contained therein that conflicts with the disclosure of the present application, is hereby incorporated herein by reference.

### BRIEF DESCRIPTION OF THE DRAWINGS

FIG. 1 shows a vehicle in accordance with embodiments of the present disclosure;

FIG. 2 shows a passenger compartment of a vehicle such as the vehicle shown in FIG. 1 in accordance with embodiments of the present disclosure;

FIG. 3 shows a perspective view of an air duct and vent system in accordance with embodiments of the present disclosure;

FIG. 4 shows a perspective sectional view of an air duct and vent system in accordance with embodiments of the present disclosure, with the barrel mechanism visible therein;

FIG. 5A shows a cross-sectional view of an air duct and vent system in accordance with embodiments of the present disclosure, with the barrel mechanism in a first orientation;

FIG. 5B shows the direction of airflow on a vehicle occupant achieved by orienting the barrel mechanism of an air duct and vent system as shown in FIG. 5A, in accordance with embodiments of the present disclosure;

FIG. 6A shows a cross-sectional view of an air duct and vent system in accordance with embodiments of the present disclosure, with the barrel mechanism in a second orientation;

FIG. 6B shows the direction of airflow on a vehicle occupant achieved by orienting the barrel mechanism of an air duct and vent system as shown in FIG. 6A, in accordance with embodiments of the present disclosure;

FIG. 7A shows a cross-sectional view of an air duct and vent system in accordance with embodiments of the present disclosure, with the barrel mechanism in a third orientation;

FIG. 7B shows the direction of airflow on a vehicle occupant achieved by orienting the barrel mechanism of an air duct and vent system as shown in FIG. 7A, in accordance with embodiments of the present disclosure;

FIG. 8A shows a cross-sectional view of an air duct and vent system in accordance with embodiments of the present disclosure, with the barrel mechanism in a fourth orientation; and

FIG. 8B shows the direction of airflow on a vehicle occupant achieved by orienting the barrel mechanism of an air duct and vent system as shown in FIG. 8A, in accordance with embodiments of the present disclosure.

### DETAILED DESCRIPTION

Embodiments of the present disclosure will be described in connection with a vehicle, and more particularly with respect to an automobile. However, for the avoidance of doubt, the present disclosure encompasses the use of the aspects described herein in vehicles other than automobiles.

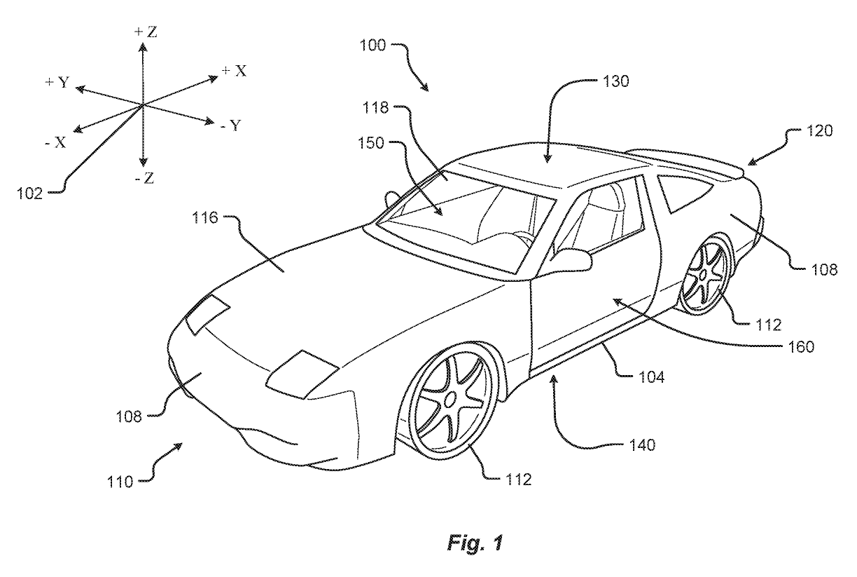

FIG. 1 shows a perspective view of a vehicle 100 in accordance with embodiments of the present disclosure. The vehicle 100 comprises a vehicle front 110, vehicle aft 120, vehicle roof 130, at least one vehicle side 160, a vehicle undercarriage 140, and a vehicle interior 150. The vehicle 100 may include a frame 104, one or more body panels 108 mounted or affixed thereto, and a windshield 118. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Coordinate system 102 is provided for added clarity in referencing relative locations in the vehicle 100. In this detailed description, an object is forward of another object or component if the object is located in the −X direction relative to the other object or component. Conversely, an object is rearward of another object or component if the object is located in the +X direction relative to the other object or component.

The vehicle 100 may be, by way of example only, an electric vehicle or a gas-powered vehicle. Where the vehicle 100 is an electric vehicle, the vehicle 100 may comprise one or more electric motors powered by electricity from an on-board battery pack. The electric motors may, for example, be mounted near or adjacent an axis or axle of each wheel 112 of the vehicle, and the battery pack may be mounted on the vehicle undercarriage 140. In such embodiments, the front compartment of the vehicle, referring to the space located under the vehicle hood 116, may be a storage or trunk space. Where the vehicle 100 is a gas-powered vehicle, the vehicle 100 may comprise a gas-powered engine and associated components in the front compartment (under the vehicle hood 116), which engine may be configured to drive either or both of the front wheels 112 and the rear wheels 112. In some embodiments where the vehicle 100 is gas-powered, the gas-powered engine and associated components may be located in a rear compartment of the vehicle 100, leaving the front compartment available for storage or trunk space or for other uses. In some embodiments, the vehicle 100 may be, in addition to a battery-powered electric vehicle and a gas-powered vehicle, a hybrid electric vehicle, a diesel-powered vehicle, or a fuel cell vehicle.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, buses, automobiles, trains, railed conveyances, boats, ships, marine conveyances, submarine conveyances, airplanes, space craft, flying machines, human-powered conveyances, and the like.

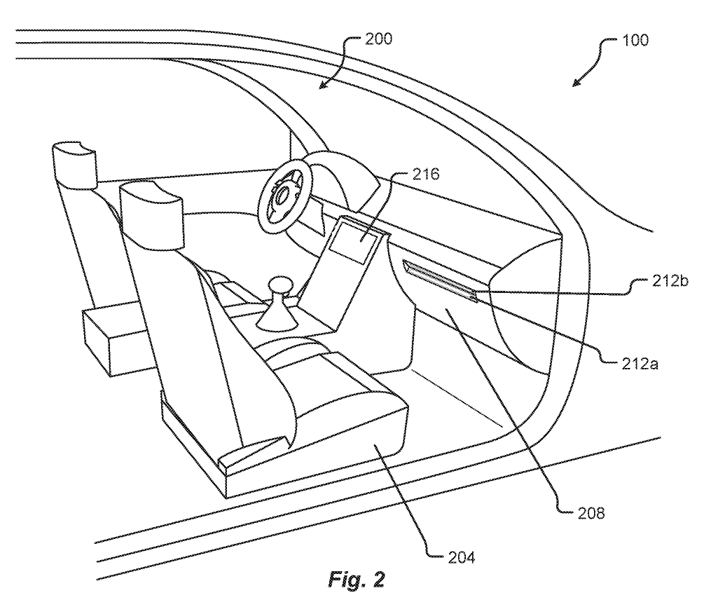

Referring now to FIG. 2, a vehicle passenger cabin 200 of a vehicle 100 according to embodiments of the present disclosure includes a passenger seat 204, a driver seat 206, and a dashboard or instrument panel or dash panel (all of which terms may be used interchangeably herein) 208. A climate control system of the vehicle 100 is accessible from the passenger compartment 200 via a touchscreen 216, through which an occupant of the vehicle 100 may input, for example, a desired temperature of the passenger cabin 200, and/or a desired vertical aiming point or direction of airflow into the cabin (e.g., low, middle, high). Based on the input information, the climate control system may actuate one or more motors to control one or more air vents configured to discharge air into the passenger cabin, and/or may activate and control an HVAC module to ensure that properly conditioned air is introduced into the passenger compartment 200.

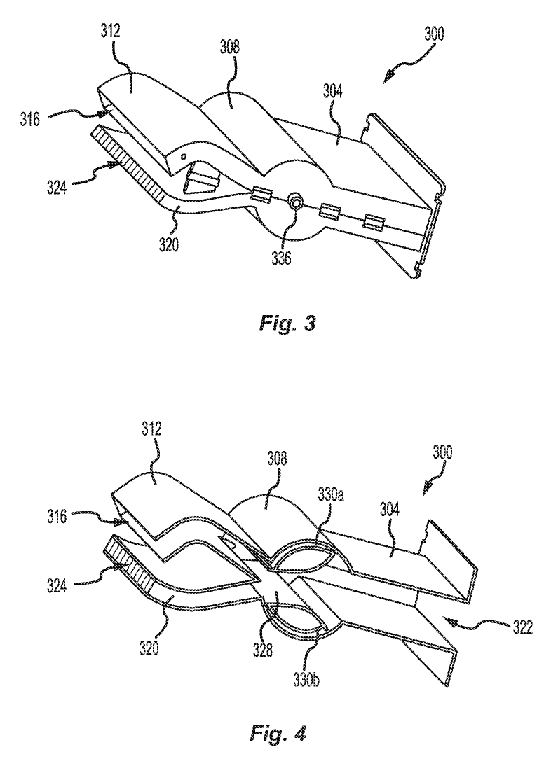

In accordance with embodiments of the present disclosure, the dashboard may include one or more pairs of air registers or vents, such as the vents 212a and 212b, through which heated, cooled, or unconditioned air may be introduced into the passenger compartment for climate control and ventilation purposes. Each pair of air vents 212a and 212b is connected to a barrel mechanism such as that described below with respect to FIGS. 3-8B, and is configured to channel fresh or recirculated air (e.g., from an HVAC module (not shown in FIG. 2) of the vehicle 100), as appropriate, to the passenger cabin 200. Although FIG. 2 shows a pair of vents 212a and 212b positioned only in front of the passenger 204, other pairs of vents may be positioned adjacent a windshield of the vehicle 100 for defrost purposes, or in front of (or otherwise near) the driver seat 206, or elsewhere in the passenger cabin 200 as necessary to ensure desirable airflow throughout the passenger cabin 200. In vehicles 100 comprising more than one row of seats, one or more pairs of air vents 212a and 212b may be positioned immediately in front of or in close proximity to each row of seats so as to supply air to the occupant(s) of each row of seats. For example, a pair of air vents 212a and 212b may be positioned behind a first row of seats for supplying air to the occupants of a second row of seats positioned behind the first row of seats. One or more additional pairs of air vents 212a and 212b may be positioned at or near the floor of the passenger cabin 200, for supplying air to the passenger cabin 200 at or near the feet of the occupants of the passenger cabin 200. Further, in some embodiments, pairs of air vents 212a and 212b may be positioned at or near the sides of the dashboard 208 for defrosting one or more side windows of the vehicle 100; and in or near the ceiling of the vehicle 100 for discharging air onto occupants of the vehicle 100 from above. Any number of pairs of air vents 212a and 212b may be included in the passenger cabin 200. Moreover, traditional air vents may be included in one or more places of the passenger cabin in addition to pairs of air vents 212a and 212b according to embodiments of the present disclosure.

Referring now to FIGS. 3 and 4, an air vent 300 according to one embodiment of the present disclosure comprises an air duct 304 with an intake 332, which is in fluid communication with a barrel housing 308. The barrel housing 308 is, in turn, in fluid communication with an upper air channel 312 terminating in an upper vent 316, and with a lower air channel 320 terminating in a lower vent 324. The air vent 300 thus constitutes a barrel valve for directing air, in varying combinations and/or ratios, into the upper air channel 312 and the lower air channel 320. A barrel valve in other embodiments may be used to direct fluids other than air, in varying combinations and/or ratios, into a plurality of channels.

The upper vent 316 and lower vent 324 correspond to the air vents 212a and 212b, respectively, shown in FIG. 2. A barrel 328 positioned within the barrel housing 308 comprises an upper vane 330a and a lower vane 330b, which are fixedly secured to each other (e.g., by a disk positioned at each end thereof). The barrel 328 is rotatably secured to the housing 308. A barrel axle 336 extends from the barrel (and along a central axis of the barrel) through the barrel housing 308 and can be operably connected to a motor or other mechanism configured to rotate the barrel 328 based on control signals received from a climate control system of the vehicle 100. Alternatively, the barrel axle 336 may be operably connected to a manual rotation mechanism that allows an occupant of the vehicle 100 to manually rotate the barrel 328 to achieve desired airflow aiming.

The air duct 304 and intake 332 may have any desirable shape, provided that air flowing therethrough is channeled into the barrel housing 308. The barrel housing 308 is shaped to contain the barrel 328 and to minimize the amount of space between the interior surface of the housing 308 and the outer surfaces of the barrel 328, to minimize the flow of air between the barrel 328 and the housing 308 and to maximize the flow of air through the central channel between the vanes 330a and 33b of the barrel 328. In some embodiments, one or more flaps, seals, gaskets, and/or other devices may be provided between the housing 308 and the surfaces of the barrel 328 that are positioned immediately adjacent the housing 308, to prevent the flow of air between the outside surfaces of the barrel 328 and the inside surface of the housing 308, and thus to channel all or substantially all of the air entering via the air duct 304 through the central channel created by the upper vane 330a and the lower vane 330b of the barrel 328.

The upper vent 316 and lower vent 324 may be high aspect ratio vents with a length several times greater than the width thereof, so as to discharge a “sheet” or “plane” of air therefrom. In some embodiments, the length of the upper vent 316 and of the lower vent 324 may be eight times greater than the width thereof. In other embodiments the length of the upper vent 316 and of the lower vent 324 may be more or less than eight times greater than the width thereof.

The upper air channel 312 and the lower air channel 320 are configured to direct incoming air, which has been channeled through the housing 308 by the vanes 330a and 330b of the barrel 328, to the upper vent 316 and the lower vent 324, respectively. Moreover, the upper air channel 312 and the upper vent 316 are configured to direct air downward, into the path of air being discharged from the lower vent 324, and the lower air channel 320 and lower vent 324 are configured to direct air upward, into the path of air being discharged from the upper vent 316. The intersection of the sheets or planes of air being discharged by the upper vent 316 and the lower vent 320 permits vertical aiming of airflow from the air vent 300, as described in greater detail below.

Additionally, the angle (measured relative to a horizontal or vertical plane) at which air is discharged from the upper air channel 312 and upper vent 316 determines the lowest aiming point of the air vent 300, and the angle (again measured relative to a horizontal or vertical plane) at which air is discharged from the lower air channel 320 and lower vent 324 determines the highest aiming point of the air vent 300. The lowest aiming point of the air vent 300 is achieved when the lower air channel 320 is completely blocked by the barrel 328, such that all air flowing through the air vent 300 is channeled into the upper air channel 312. Similarly, the highest aiming point of the air vent 300 is achieved when the upper air channel 312 is completely blocked by the barrel 328, such that all air flowing through the air vent 300 is channeled into the lower air channel 320.

Although FIGS. 3 and 4 depict an air vent 300 of particular dimensions, the disclosure provided in connection with FIGS. 3 and 4 is not intended to be limiting. Thus, for example, the air duct 304 may have a different shape than that shown in FIGS. 3 and 4, including a different cross-sectional shape, a different length, a different width, and/or a different height. The housing 308 may be larger or smaller, and the barrel 328 may be correspondingly larger or smaller. The vanes 330a, 330b of the barrel 328 may be shaped differently, provided that the vanes are shaped and spaced so as to define a central channel and enable the selective channeling of air entering the housing 308 into one or both of the upper air channel 312 and the lower air channel 324 (or a portion thereof). In some embodiments of the present disclosure, the barrel may comprise more than two vanes. The upper air channel 312 and the lower air channel 316 may have a different cross-section, height, width, and/or length than shown in FIGS. 3 and 4, including a different relative height, width, and/or length as compared to the housing 308 and/or the air duct 304. The curvature of the upper air channel 312 and of the lower air channel 320 may be more or less pronounced. In some embodiments, the air vents 316 and 324 may be completely open, while in other embodiments, the air vents 316 and 324 may comprise a plurality of vanes configured to ensure that air flowing through the vents 316 and 324 exits the vents 316 and 324 in the same direction. In still other embodiments, the vents 316 and 324 may comprise a plurality of vanes, or any other mechanism known in the art, to enable horizontal aiming of air flowing therethrough. While the vents 316 and 324 of the present disclosure are depicted with approximately equal cross sections (when viewed perpendicular to the direction of air flow therethrough), in some embodiments one of the vents 316 and 324 may have a larger or smaller cross section than the other o the vents 316 and 324.

In operation, conditioned or unconditioned air (depending on a current configuration of the climate control system of the vehicle 100, which may be automatically or manually set) enters the air duct 304 via the intake 332. The barrel 328, depending on its angular orientation relative to the barrel housing 308, channels the incoming air to one or both of the upper air channel 312 and the lower air channel 320. In some orientations, the barrel 328 fully or partially blocks one or both of the upper air channel 312 and the lower air channel 320, thus allowing adjustment of the proportion of the mass flow rate of air through the upper air channel 312, on one hand, and through the lower air channel 320, on the other. The configuration of the vanes 330a, 330b of the barrel 328 is such that one of the upper air channel 312 and the lower air channel 320 can remain fully open while the other of the upper air channel 312 and the lower air channel 320 is closed in varying degrees. Because the cross section of the upper vent 316 and the lower vent 324, respectively, is fixed, any change in mass flow rate through each of the upper air channel 312 and the lower air channel 320 results in a change in the velocity of air as it exits the upper channel 312 (through the vent 316) and the lower air channel 320 (through the vent 324), respectively, which change in velocity in turn affects the extent to which airstreams exiting the upper and lower vents 316 and 324, respectively, are deflected.

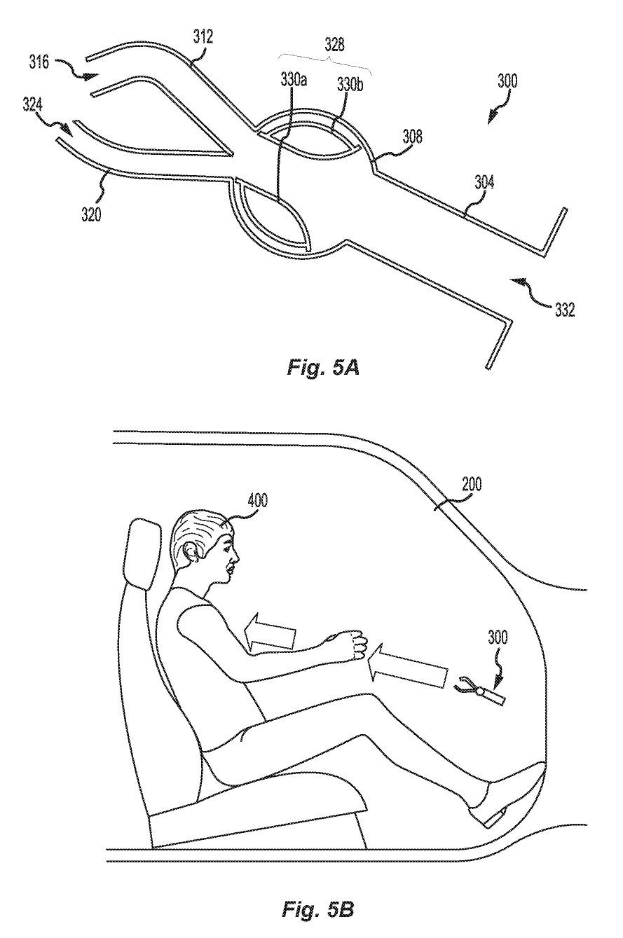

Referring now to FIG. 5A, with the barrel 328 in a first orientation in which both the upper air channel 312 and the lower air channel 320 are fully open, the mass flow rate of air through the upper air channel 312 and the lower air channel 320 will be approximately equal. Whether the mass flow rate through each of the upper and lower air channels 312 and 320 is actually equal will depend, for example, upon such factors as whether the cross-sectional area (measured perpendicular to the direction of air flow) of the upper and lower air channels 312 and 320 is identical; and whether air flows through the air duct 304 and housing 308 (e.g., between the vanes 330a and 330b of the barrel 328) at a constant mass flow rate across the entire cross-sectional area (measured, again, perpendicular to the direction of air flow) thereof. For the avoidance of doubt, the present disclosure does not require such conditions, which may be varied to obtain optimal airflow characteristics for a given setting.

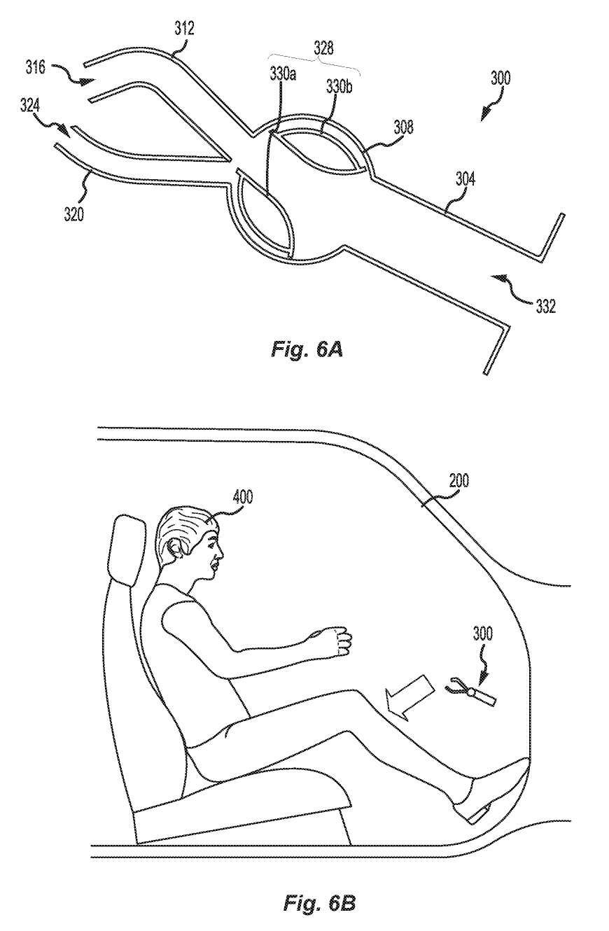

FIG. 5B shows the resulting direction of airflow into the passenger cabin when the barrel 328 of the air vent 300 is in the first position, relative to a vehicle occupant 400. Although the dashboard 208 is not shown in FIGS. 5B, 6B, 7B, and 8B, it should be understood that the air vent 300 in each of those figures is positioned within the dashboard, with the air vents 316 and 324 flush with one or more surfaces thereof. The airflow directions illustrated in FIG. 5B, as well as in FIGS. 6B, 7B, and 8B, are illustrative and are based upon the position and orientation of the vent 300 in the dashboard 208, the angles at which the upper air channel 312 (and corresponding vent 316) and lower air channel 320 (and corresponding vent 324) discharge air into the passenger cabin 200, the position of the occupant within the passenger cabin 200 (as determined, for example, by the position of the driver seat 206 and/or passenger seat 204), and other such factors, all of which may be varied from the configuration depicted in FIGS. 5B, 6B, 7B, and 8B. However, FIGS. 5A through 8B demonstrate how the angular orientation of the barrel 328 within the housing 308 of an air vent 300 according to embodiments of the present disclosure correlates with the resulting direction of airflow into the passenger cabin 200, which correlation information is useful regardless of the specific configuration of a given air vent 300 and passenger cabin 200.

Returning, then, to FIG. 5B, the airstreams emanating from the upper and lower vents 316 and 324, respectively, impinge on and deflect each other, resulting in an overall airflow directed towards the torso of the vehicle occupant 400. Stated differently, the airstream exiting the upper vent 316 pushes the airstream exiting the lower vent 324 from an upward angle to a more horizontal angle. Similarly, the airstream exiting the lower vent 324 pushes the airstream exiting the upper vent 316 from a downward angle to a more horizontal angle. Once deflected, the airstreams from the upper and lower vents 316 and 324, respectively, flow toward the vehicle occupant 400.

With respect to FIG. 6A, the barrel 328 may be rotated to a second orientation in which the lower air channel 320 is blocked by the lower vane 330b, and all of the air entering through the intake 332 is channeled into the upper air channel 312. Although FIG. 6A shows a slight gap between the lower vane 330b and the lower surface of the upper air channel 312, through which air could travel into the lower air channel 320, air vents according to some embodiments of the present disclosure may utilize one or more of, for example, tight tolerances and gap seals to completely seal off the entrance to the lower air channel 320 when the barrel 328 is in the second orientation, and/or to completely seal off the entrance to the upper air channel 312 when the barrel 328 is oriented so as to direct all air entering the air vent 300 via the intake 332 into the lower air channel 320.

FIG. 6B shows the air flow into the passenger cabin resulting from placement of the barrel 328 in the second orientation as shown in FIG. 6A. Specifically, with all of the air entering via the intake 332 of the air vent 300 being channeled into the upper air channel 312, all of that air is directed out of the air vent 300 via the upper vent 316. With no air exiting the lower vent 324 and impinging on or deflecting the air flowing out of the upper vent 316, the air flowing out of the upper vent 316 continues in the same downward direction at which it exits the upper vent 316, and thus travels to a spot below the knees of the vehicle occupant 400. As noted above, if the air vent 300 were positioned and/or oriented differently within the vehicle cabin 200, and/or if the vehicle occupant 400 were positioned and/or oriented differently within the vehicle cabin 200, then the airflow resulting from the second orientation might be directed toward a different part of the passenger cabin 200 and/or of the vehicle occupant 400. Regardless, however, the second orientation (in which the lower air channel 320 is closed off, and all of the air passing through the air vent 300 is channeled into the upper air channel 312) corresponds to the lowest available aiming point of the air vent 300.

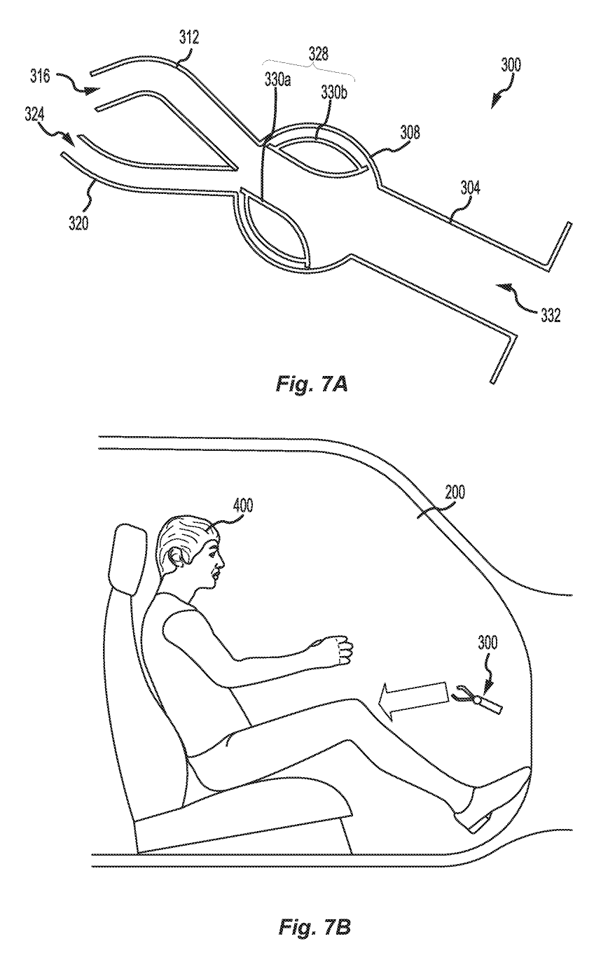

FIG. 7A shows the barrel 328 in a third orientation, with the lower air channel 320 partially open and the upper air channel 312 fully open. With this orientation of the barrel 328 (and given that the upper and lower air channels 312 and 320, respectively, of the embodiment shown in the figures have approximately equal cross-sectional areas, as measured perpendicular to the direction of air flow therethrough), the mass flow rate of air through the upper air channel 312 will be higher relative to the mass flow rate of air through the lower air channel 320.

FIG. 7B shows the flow of air from the air vent 300 into the passenger cabin 200 as a result of the barrel 328 being placed in the third orientation. Specifically, the airflow exiting from the lower air channel 320 causes some deflection of the airflow exiting from the upper air channel 312, but not as much deflection as occurred when the lower air channel 320 was fully open. As a result, a stream of air is directed toward the knees of the vehicle occupant 400. In other words, the airstream generated by the air vent 300 with the barrel 328 in the third configuration pass through the cabin at an angle lower than when both the upper and lower air channels 312 and 320, respectively, were fully open, but higher than when the lower air channel 320 was fully closed.

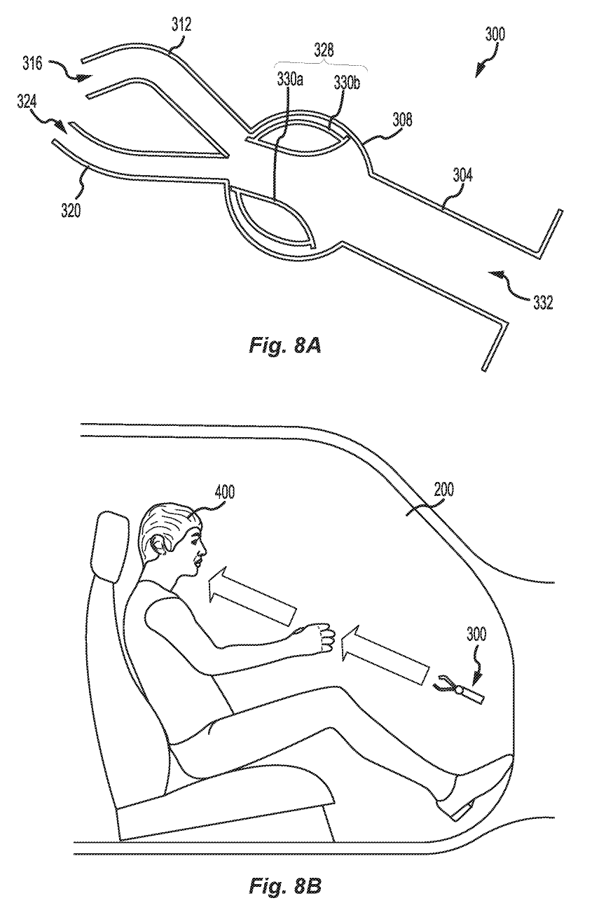

FIG. 8A shows the barrel 328 of the air vent 300 in a fourth orientation, with the lower air channel 320 fully open and the upper air channel 312 only partially open. In this configuration, the mass flow rate of air through the upper air channel 312 will be lower relative to the mass flow rate of air through the lower air channel 320.

FIG. 8B shows the resulting airstream into the passenger cabin when the barrel 328 of the air vent 300 is in the fourth orientation. Specifically, with a greater mass flow rate of air passing through the lower air vent 324 than through the upper air vent 316, the air flowing out of the lower air vent 324 is deflected slightly downward from its upward trajectory. As a result, the airflow generated by the air vent 300 travels at an upward angle toward the lower face/neck of the vehicle occupant 400. The upward angle, however, is not as steep of an angle as the airflow would travel if the upper air channel 312 were completely closed off, and the entirety of the air flowing through the air vent 300 were directed into the lower air channel 320 and then upward out of the lower vent 324.

As persons of ordinary skill in the art will appreciate upon review of the present disclosure, any number of aiming points may be achieved by air vents of the present disclosure, bounded only by the lowermost aiming point (determined by the angle at which air exits the upper air vent 316) and the uppermost aiming point (determined by the angle at which air exits the lower air vent 324). Moreover, the ability to control the direction of airflow from air vents of the present disclosure without the use of vanes positioned at the outlet(s) of the air vents, but instead with a rotatable barrel 328 positioned within a barrel housing 308 that is physically separate from the upper and lower air channels 312 and 320 and upper and lower vents 316 and 324, facilitates the use of high aspect ratio vents, which in turn can be discreetly positioned within an instrument panel 208 or other portion of a vehicle 100 to achieve an aesthetically pleasing interior design.

As noted above, the barrel 328 may be controlled automatically or manually. Where the barrel 328 is controlled automatically, such control may be accomplished by or via a climate control system of the vehicle 100. Such a climate control system may comprise, for example, a processor, a user input device (such as a touchscreen), one or more motors operatively connected to one or more air vents such as the air vents 300, and a memory or other computer-readable storage medium storing instructions for execution by the processor that, when executed, cause the processor to receive an input from a user via the user input device, analyze the input, and based on the analyzed input send one or more control signals to one or more of the motors operatively connected to one or more air vents, and/or to an HVAC module of the vehicle 100, in response to the user input. The climate control system may further comprise a feedback loop, which may, for example, comprise temperature and/or other sensors for sensing characteristics of the climate within the passenger compartment 200 and reporting the sensed information to the processor of the climate control system.

For example, a climate control system of a vehicle 100 may be configured to receive a desired temperature from a vehicle occupant and then adjust one or more climate control settings to achieve the desired temperature in the quickest and/or most efficient manner possible. Alternatively, the climate control system may be configured to receive an indication of a desired airflow aiming point (e.g., low, middle, high, or legs, torso, head), and may send a control signal that causes a motor to rotate an axle 336 so as to adjust a barrel 328 of an air vent 300 to achieve the desired airflow aiming point. In still further embodiments, the climate control system may be configured to receive an indication of a desired airflow pattern (e.g., a constantly changing aiming point varying between the highest available aiming point and the lowest available aiming point, or aiming at each of three different levels (such as low, middle, and high) for one minute at a time) and to adjust the barrel 328 automatically (e.g., via control signals transmitted to a motor operatively connected to the barrel 328 via an axle 336) to achieve the desired airflow pattern.

While the air vent 300 described herein is oriented to achieve vertical aiming of an airflow within a passenger cabin 200, other air vents according to embodiments of the present disclosure may be configured to achieve vertical aiming of airflow in a setting other than a vehicle passenger cabin, and still other embodiments of the present disclosure may be configured to achieve horizontal aiming of an airflow within a passenger cabin 200 or in another context. In embodiments configured for horizontal aiming, the barrel 328 is configured to rotate around a substantially vertical axis, rather than a substantially horizontal axis (as in the air vent 300), and to channel incoming air into left and right air channels rather than into upper and lower air channels 312 and 324.

Moreover, a barrel such as the barrel 328 comprising vanes such as the vanes 330a, 330b may be used as a valve to channel fluids, including but not limited to air, from an intake channel into two or more outlet channels, with varying mass flow rate proportions (including, for example, by channeling fluid from the intake channel to only the first of two outlet channels, by channeling fluid from the intake channel to only the second of two outlet channels, and by channeling fluid from the intake channel, in varying mass flow rate proportions, to both of the two outlet channels). Notably, such a barrel may be used regardless of whether the outlet channels are configured to direct the fluid in question into intersecting flow paths, and regardless of whether the outlet channels are configured with a high aspect ratio.

The features of the various embodiments described herein are not intended to be mutually exclusive. Instead, features and aspects of one embodiment may be combined with features or aspects of another embodiment. Additionally, the description of a particular element with respect to one embodiment may apply to the use of that particular element in another embodiment, regardless of whether the description is repeated in connection with the use of the particular element in the other embodiment.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

The systems and methods of this disclosure have been described in relation to the air vents positioned in a vehicle. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description, for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Embodiments include an air vent, comprising: a barrel housing; an air duct positioned to channel air from an intake to the barrel housing; an upper air channel positioned to channel air from the barrel housing to an upper vent; a lower air channel positioned to channel air from the barrel housing to a lower vent; and a barrel rotatably secured within the barrel housing, the barrel comprising a plurality of vanes defining a central air channel, the plurality of vanes fixedly secured to each other.

Aspects of the above air vent include: an axle extending from the barrel along a central axis of the barrel to outside the barrel housing, wherein rotation of the axle causes the barrel to rotate; wherein the plurality of vanes are configured to selectively channel air into the upper air channel only, the lower air channel only, or both the upper air channel and the lower air channel; wherein the plurality of vanes are configured to partially close one of the upper and lower air channels to airflow while the other of the upper and lower air channels is fully open to airflow; wherein the upper vent directs air downward and the lower vent directs air upward; wherein air exiting the upper vent impinges upon air exiting the lower vent, and air exiting the lower vent impinges upon air exiting the upper vent; wherein air exiting the upper vent deflects air exiting the lower vent, and air exiting the lower vent deflects air exiting the upper vent; wherein rotation of the barrel changes the proportion of the mass flow rate of air through each of the upper air channel and the lower air channel; wherein each of the upper vent and the lower vent has an approximately equal cross-sectional area; and wherein each of the upper vent and the lower vent has a length that is at least 8 times greater than a width thereof.

Embodiments also include a vehicle comprising: a passenger cabin; and an air vent configured to discharge air into the passenger cabin, the air vent comprising: an air duct comprising an intake; a barrel housing affixed to the air duct opposite the intake; an upper air channel extending from the barrel housing to an upper vent; a lower air channel extending from the barrel housing to a lower vent; and a barrel rotatably secured within the barrel housing and configured to selectively direct air from the air duct into one or both of the upper air channel and the lower air channel.

Aspects of the above vehicle include: wherein the barrel comprises an upper vane and a lower vane, the upper vane and lower vane being fixedly secured to each other and defining a central air channel; wherein the barrel comprises an axle extending along a central axis of the barrel to outside the housing, the axle being fixedly secured to the barrel such that rotation of the axle causes rotation of the barrel; a climate control system configured to automatically rotate the barrel based upon a user input; wherein the upper vent is oriented to direct air downward and the lower vent is configured to direct air upward; wherein air exiting the upper vent impinges upon and deflects air exiting the lower vent, and air exiting the lower vent impinges upon and deflects air exiting the upper vent; wherein an amount of deflection of air exiting the upper and lower vents is adjustable by rotating the barrel; and wherein the air vent is positioned within a dashboard.

Embodiments further include a barrel valve comprising: an intake duct for receiving air; a barrel housing in fluid communication with the intake duct; an upper air channel in fluid communication with the barrel housing; a lower air channel in fluid communication with the barrel housing; and a barrel rotatably secured within the barrel housing, the barrel comprising an upper vane and a lower vane, the upper vane and lower vane defining a central channel therebetween, the barrel configured to channel air from the intake duct to one or both of the upper air channel and the lower air channel.

Aspects of the above barrel valve include: wherein the upper air channel terminates at an upper vent, the lower air channel terminates at a lower vent, air exiting the upper vent contacts air exiting the lower vent, and air exiting the lower vent contacts air exiting the upper vent.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “determine,” “calculate,” “compute,” and variations thereof, as used herein, are used interchangeably and include any type of methodology, process, mathematical operation or technique.

Examples of processors as referenced herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARM926EJS™ processors. A processor as disclosed herein may perform computational functions using any known or future-developed standard, instruction set, libraries, and/or architecture.

What is claimed is:

1. An air vent, comprising:
a barrel housing;
an air duct positioned to channel air from an intake to the barrel housing;
an upper air channel positioned to channel air from the barrel housing to an upper vent;
a lower air channel positioned to channel air from the barrel housing to a lower vent; and
a barrel rotatably secured within the barrel housing, the barrel comprising a plurality of vanes defining a central air channel, the plurality of vanes fixedly secured to each other.

2. The air vent of claim 1, further comprising an axle extending from the barrel along a central axis of the barrel to outside the barrel housing, wherein rotation of the axle causes the barrel to rotate.

3. The air vent of claim 1, wherein the plurality of vanes are configured to selectively channel air into the upper air channel only, the lower air channel only, or both the upper air channel and the lower air channel.

4. The air vent of claim 3, wherein the plurality of vanes are configured to partially close one of the upper and lower air channels to airflow while the other of the upper and lower air channels is fully open to airflow.

5. The air vent of claim 1, wherein the upper vent directs air downward and the lower vent directs air upward.

6. The air vent of claim 5, wherein air exiting the upper vent impinges upon air exiting the lower vent, and air exiting the lower vent impinges upon air exiting the upper vent.

7. The air vent of claim 6, wherein air exiting the upper vent deflects air exiting the lower vent, and air exiting the lower vent deflects air exiting the upper vent.

8. The air vent of claim 6, wherein rotation of the barrel changes the proportion of the mass flow rate of air through each of the upper air channel and the lower air channel.

9. The air vent of claim 1, wherein each of the upper vent and the lower vent has an approximately equal cross-sectional area.

10. The air vent of claim 1, wherein each of the upper vent and the lower vent has a length that is at least 8 times greater than a width thereof.

11. A vehicle comprising:
a passenger cabin; and
an air vent configured to discharge air into the passenger cabin, the air vent comprising:
an air duct comprising an intake;
a barrel housing affixed to the air duct opposite the intake;
an upper air channel extending from the barrel housing to an upper vent;
a lower air channel extending from the barrel housing to a lower vent; and
a barrel rotatably secured within the barrel housing and configured to selectively direct air from the air duct into one or both of the upper air channel and the lower air channel.

12. The vehicle of claim 11, wherein the barrel comprises an upper vane and a lower vane, the upper vane and lower vane being fixedly secured to each other and defining a central air channel.

13. The vehicle of claim 11, wherein the barrel comprises an axle extending along a central axis of the barrel to outside the housing, the axle being fixedly secured to the barrel such that rotation of the axle causes rotation of the barrel.

14. The vehicle of claim 13, further comprising a climate control system configured to automatically rotate the barrel based upon a user input.

15. The vehicle of claim 11, wherein the upper vent is oriented to direct air downward and the lower vent is configured to direct air upward.

16. The vehicle of claim 15, wherein air exiting the upper vent impinges upon and deflects air exiting the lower vent, and air exiting the lower vent impinges upon and deflects air exiting the upper vent.

17. The vehicle of claim 16, wherein an amount of deflection of air exiting the upper and lower vents is adjustable by rotating the barrel.

18. The vehicle of claim 11, wherein the air vent is positioned within a dashboard.

19. A barrel valve comprising:
an intake duct for receiving air;
a barrel housing in fluid communication with the intake duct;
an upper air channel in fluid communication with the barrel housing;
a lower air channel in fluid communication with the barrel housing; and
a barrel rotatably secured within the barrel housing, the barrel comprising an upper vane and a lower vane, the upper vane and lower vane defining a central channel therebetween, the barrel configured to channel air from the intake duct to one or both of the upper air channel and the lower air channel.

20. The barrel valve of claim 19, wherein the upper air channel terminates at an upper vent, the lower air channel terminates at a lower vent, air exiting the upper vent contacts air exiting the lower vent, and air exiting the lower vent contacts air exiting the upper vent.
